(19) United States
(12) Patent Application Publication
(10) Pub. No.: US 2008/0271705 A1
(43) Pub. Date: Nov. 6, 2008

(54) Variable compression engine

(76) Inventor: John T. Sims, Bainbridge, GA (US)

Correspondence Address: Pennington, Moore, Wilkinson, Bell & Dunbar, P.A., Post Office Box 10095, Tallahassee, FL, 32302-2095, US

(21) Appl. No.: 12/079,102

(22) Filed: May 5, 2008

Related U.S. Application Data
(63) Continuation-in-part of application No. 11/434,699, filed on May 16, 2006, now abandoned.

(51) Int. Cl. F02M 7/00

(52) U.S. Cl. 123/435

(57) ABSTRACT

A variable compression internal combustion engine having a compression that is variable via a compression relief valve (in addition to the intake and exhaust valves) that is precisely timed and controlled by a selectable timing hydraulic pump or other means and designed to relieve compression in the combustion chamber during a portion of the compression stroke of an engine.

### CROSS-REFERENCES TO RELATED APPLICATIONS

This application is a continuation-in-part of U.S. application Ser. No. 11/434,699, which listed the same inventor.

### STATEMENT REGARDING FEDERALLY SPONSORED RESEARCH OR DEVELOPMENT

Not Applicable.

### MICROFICHE APPENDIX

Not Applicable

### BACKGROUND OF THE INVENTION

1. Field of the Invention

The present invention relates generally to combustion engines, and more specifically to a variable compression engine, wherein compression within the combustion chamber is reduced during the compression stroke by opening a relief valve.

2. Description of the Related Art

The cost of petroleum fuels, environmental concerns, and fuel supply consistency from politically unstable regions of the world, all cause concern for the viability of gasoline-based fuels. Further, as oil resources dwindle world-wide and demand for oil increases, particularly in developing counties, efforts to utilize other energy resources increase.

Accordingly, more and more countries are turning to alternative fuel sources wherever possible. For example, Brazil (the largest ethanol producer in the world) has substantially converted its vehicle fleet to ethyl alcohol (ethanol) as a fuel stock. Since the United States is the second largest ethanol producer in the world, ready fuel stocks exist for supplying America's vehicular fleet.

Alternative fuels such as ethanol have the further benefit of reducing the generation of NOx compounds, thereby effectively improving air quality. Furthermore, since oil-based compounds, such as gasoline, contaminate soils and water, whereas ethanol readily disperses and evaporates from water, improvements to soil and water quality are also achievable through use of alcohol-based fuels.

However, in spite of the benefits, such alternative fuels are not readily introduced into the market due to a lack of equipment that can utilize them efficiently and/or a lack of infrastructure to provide them. Further compounding the problem is that an engine designed for one type of fuel is not adaptable to utilize a different fuel without great difficulty.

While there are “selective fuel vehicles” available today, and they offer limited ability to utilize alcohols as fuel, they do not improve the combustion process for alcohol, they merely add more fuel (typically by altering the fuel injector timing) to compensate for the lower energy level of alcohols, and, thus, the alcohol fuels are utilized very inefficiently. The fixed compression ratio available in prior art engines results in a 30-35% reduction in overall fuel efficiency when running alcohol in an engine designed to run on gasoline. Moreover, this reduced efficiency offsets the cost reductions that would otherwise be achieved, and aggravates air, water and soil pollution.

In order to gain market acceptance for a selective fuel vehicle, the vehicle must provide the user with confidence that it can be fueled while travelling away from its home base. Unfortunately, existing vehicles are limited to use of individual fuels, or use of fuels that are only slight variations of each another, or alternately are inefficient and/or require modifications to run on alternative fuels. For instance, gasoline fuel stations are ubiquitous and the consumer has high confidence that he/she will be able to obtain fuel wherever he/she goes. However, alternative renewable fuels, such as ethanol, lack such infrastructure. Thus, a driver will not purchase a vehicle to run on ethanol if he/she does not know for certain that he/she will be able to obtain ethanol while out and about. On the other hand, if a driver can purchase a vehicle that will run on gasoline or on ethanol without conversion, and without any burden placed on the driver to make any changes, such a driver will willingly select a variable fuel vehicle with confidence.

As ethanol stations slowly increase their presence, drivers will slowly gain the confidence to purchase ethanol fueled vehicles. However, if they have the confidence that they can utilize gasoline or ethanol whenever they find either such station, drivers will rapidly select such adaptable vehicles and the change over to ethanol fuels will be more rapidly achieved.

In order to provide for such consumer confidence, vehicle engines must be capable of operating on a variety of fuels. However, this has not heretofore been the norm.

For instance, internal combustion engines are typically designed to operate on a single specific quality and type of fuel, most commonly gasoline at approximately 87 octane rating. As alternative fuels enter the market, engines must be designed to accommodate them. However, different fuels, or different qualities of a specific fuel, vary in their energy content (as expressed by octane rating), and, thus, require optimum conditions for the release of the energy contained therein. To adapt to different fuels and provide optimum efficiency therefrom, the compression within the engine must be changed.

For instance, gasoline fuel engines typically are designed within a range of 7-9 to 1 compression ratio, while ethanol based fuels advantageously utilize a 15-17 to 1 compression ratio. Recent studies conducted by the United States Environmental Protection Agency have suggested that an even higher compression ratio—such as 22.5:1—may offer additional benefits for ethanol. Unfortunately, while engines may be designed to run on ethanol, or mixtures of gasoline and ethanol, current efforts merely design to a new fixed compression and are not directed to attaining an increased efficiency through variability of compression. When changing between fuels, such previous designs have typically merely add more ethanol to make up for ethanol's lower energy content.

Typically, an internal combustion engine compresses the fuel/air mixture prior to ignition thereof. Most commonly, the Otto cycle is utilized, comprising four strokes: 1) Intake of fuel (intake stroke) through an intake valve, during which the piston moves in its cylinder away from the combustion chamber thereby increasing the volume above the piston and drawing a vacuum which pulls fuel/air in through an intake valve; 2) compression of the fuel (compression stroke), during which the piston moves in its cylinder towards the combustion chamber reducing the space above the piston; 3) combustion of the fuel (power stroke), during which expanding ignited gases move the piston away from the combustion chamber; and 4) exhaust of the burned fuel/air (exhaust stroke), during which the piston moves again towards the combustion chamber, while venting spent gases through the exhaust valve. Thus, each full Otto cycle comprises two rotations of the crankshaft of the engine to accomplish the four strokes.

Ignition typically takes place slightly before the piston reaches top dead center (TDC) of the compression stroke. If the fuel/air mixture is too hot (from too much compression), an auto-ignition or pre-detonation (knock) may occur that is both detrimental physically to the structure of the engine, and further results in a loss of efficiency. Thus, selection of a correct compression is imperative for improved life and efficiency. However, in order to utilize a variety of fuels to their maximum efficiency and requiring different compressions, an engine must be designed for the maximum compression ratio fuel with reduction of compression from the maximum level as required by lower compression fuels.

Other internal combustion cycles may also require appropriate selection of compression for optimum efficiency. For instance, the four strokes may be combined into two. In a two-cycle engine (two-stroke engine), the intake and compression strokes are combined into one, with intake of fuel in the early part of the first stroke, followed by compression once the intake valve is closed. Subsequently, the fuel is ignited and then exhausted in the last portion of the combustion or power stroke. Again, as for the four-stroke engine, variability of compression will permit the use of varying fuels.

While a type of four-stroke engine, a Miller cycle engine has a similarity to a two-cycle engine in that the compression stroke of the Miller cycle includes a beginning period (sometimes considered as a fifth stroke) during which the intake valve remains open until extra fuel is pushed back out through the intake valve rather than being compressed, thereby reducing the fuel/air load. Once the intake valve closes, compression begins, but is accordingly lessened by the period during which the intake valve was open. This reduces the compression and, accordingly, the temperature of the fuel/air mix at ignition, resulting in reduced likelihood of “knocking”. This ultimately permits a higher design compression for Miller cycle engines. Unfortunately, the Miller cycle typically disadvantageously requires a supercharger to facilitate the introduction of air into the cylinder through the intake valve.

In addition to the above engine cycles, the Diesel cycle is commonly utilized for internal combustion engines. In the Diesel cycle, air that has entered the cylinder is compressed generating heat. This is followed by introduction of fuel when the piston is approximately at TDC, wherein the fuel is subsequently ignited from the heat, producing power to drive the piston downward. (Some Diesel engines may have an ignition source that retains incandescence to facilitate in the ignition of the fuel, particularly when starting.)

Diesel engines are typically designed with a fixed compression ratio that is optimum to a continuous level of power output. Alternately, Diesel engines may have compression varied by adjustment of a plate at the top of the cylinder, wherein placement of the plate closer to the piston results in higher compression, while removing the plate farther from the piston results in lower compression. Thus, variations in fuel quality can be overcome by adjustment of an optimum compression for the particular fuel in use. Unfortunately, Diesel fuels are also typically derived from oil resources, and, thus, do not alleviate the problem of short supplies of oil.

For all of the above types of engines, fuel and/or air are provided to the combustion chamber through an intake valve that opens during a portion of the intake stroke. Subsequent to combustion of the fuel/air mixture, spent fuel/air is removed through an exhaust valve that is open during a portion of the exhaust stroke. During the compression and power strokes, both the intake and exhaust valves typically remain closed, although as noted hereinbelow (and for the Miller cycle engine as described hereinabove), the intake valve may be open for a portion of the compression stroke.

During compression, as the piston extends itself within the engine cylinder, it compresses the fuel/air mixture to a selected level of compression based on a design compression ratio that is determined by the size of the combustion chamber as it varies from full retraction of the piston to full extension of the piston. Consequently, as the piston withdraws from within the cylinder, compression is reduced and vice versa. Near peak compression, the fuel/air mixture is ignited and combustion takes place providing power to the engine. While a modicum of variability of compression can be obtained by selection of the timing of firing of the igniter device, such timing can only offer a limited selectivity of the compression. Such limitation typically prevents the use of alternative fuels within an engine unless mechanical modifications are made thereto to provide different compression ratios. Such mechanical modifications are generally extensive and costly.

Accordingly, various methods have been utilized to alter compression of an operating engine. For instance, timing the opening of the intake valve to control fuel/air mass will selectively reduce or increase fuel/air mass, resulting in reduced/increased compression. Further, varying piston stroke length, such as via altering the length of a connecting rod through varying oil pressure from lubrication system, and/or via varying lift and angle of intake valve, may be utilized to vary compression. However, such an approach utilizes discrete levels of compression and precludes continuous variation.

Overlapping the opening and closing of intake and exhaust valves may be utilized to adjust compression. Varying the valve overlap period to change the fuel/air mix will increase or decrease the density of the fuel/air mix, will also result in increased or decreased compression. However, such overlap (both valves open at the same time) will cause newly introduced fuel to pass out through the exhaust and consequently be wasted.

In yet another approach, two-part pistons have been utilized, with or without upper and lower chambers, wherein the pistons vary in size by application of oil pressure channeled through crank and rods, the pistons having valves in the connecting rods, wherein the valves effectively vary the volume of the combustion chamber. Again, such an approach can only select between discrete intervals of compression and cannot be externally varied.

As a result of design constraints, such previous devices are limited to selection among fixed ratios of compression and/or rely upon the entry and variation of fuel and/or air admitted to the combustion chamber before the compression portion of the cycle begins. Thus, previous devices have lacked variation of compression during the compression stroke itself, and further lack the ability to vary the compression ratio by external means. Due to their lack of variability, such engines are not readily adaptable to changes in fuels or fuel quality. This acts as a deterrent to the acceptance of alternative fuel vehicles, since the user cannot fuel with gasoline one day, then drive out of town and fuel with ethanol the next day.

Those skilled in the art will know that a reciprocating engine's compression ratio is determined by the geometry of the moving components. Specifically, the swept volume of each cylinder is a function of the geometry of the piston, cylinder head, connecting rod, and crankshaft. The swept volume is generally not variable, though some engines now have very complex mechanisms capable of altering the distance between the crankshaft and the combustion chamber. In the vast majority of engines, these geometric relationships are not variable. Thus, for a diesel cycle, the engineers design the engine geometry to produce a compression ratio of about 20 to 1. While a design for a gasoline engine would typically employ a compression ratio of about 9 to 1. Using different fuels in the same engine therefore presents a significant engineering challenge. The present invention seeks to address this challenge.

### BRIEF SUMMARY OF THE INVENTION

Briefly described, in a preferred embodiment, the present invention provides a variable compression internal combustion engine having a compression that is variable via a compression relief valve (in addition to the intake and exhaust valves) that is precisely timed and controlled by a selectable timing hydraulic pump or other means and designed to relieve compression in the combustion chamber during a portion of the compression stroke of an engine.

The purpose of variable compression is to allow an engine having a fixed geometry between the crankshaft, connecting rod, piston, and combustion chamber to utilize different fuels (such as gasoline, ethanol, and diesel oil). The compression relief valve allows the optimum air to fuel ratio for the selected fuel by varying the engine's overall compression ratio.

The engine can be designed to a maximum compression ratio required for the highest compression fuel and the compression is reduced through removal of fuel, air, and/or fuel/air mixture during the compression stroke. The fuel exiting the third valve is returned to the fuel feed system and/or intake manifold, and is thus fully recovered without loss.

According to its major aspects and broadly stated, the present invention in its preferred form is a variable compression engine, wherein a variable compression relief valve is opened during a portion of the compression stroke of an engine to relieve compression in the combustion chamber. Gases vented through the variable compression relief valve pass through ports in the valve stem, then on to the fuel supply or intake manifold via check valves. The check valves serve to prevent backflow of air into the combustion chamber through the variable compression relief valve.

Timing of opening and closing of the variable compression relief valve can be externally timed and/or controlled. It is actuated in one embodiment via timed hydraulic pressure, such as, for exemplary purposes only, via a hydraulic pump driven by a cam operating from a camshaft that turns one rotation for each two rotations of the engine crankshaft. The timing can be adjusted to overlap the closing point of the intake valve to selectively achieve the desired compression level, and, thus, utilize a variety of fuels in a single engine. The relief valve is hydraulically opened and closed by a hydraulic pump controlled by a mechanical or electrical mechanism that selects timing of the opening of the relief valve during a portion of said compression stroke.

The intake valve of the engine may remain open for a portion of the compression stroke and be open at the same time as the relief valve. The compression may thus be varied as desired during running of the engine, or the relief valve closing point may be selectively set and fixed. Compression may then be further varied by adjusting the lift height, timing, and/or dwell of the relief valve. The relief valve may even be opened more than one time during a single compressions stroke (a pulsed operation).

More specifically, the present invention is a variable compression engine comprising compensation for a wide variety of fuels by construction of the engine to afford a high compression and then providing a mechanism for reducing the compression as required. Variable compression is achieved by the use of a third valve located in the combustion chamber. The valve is opened (timed) at the beginning of the compression stroke to release the desired amount of pressure. The valve may be actuated by hydraulic pressure from a hydraulic pump that is timed mechanically or electrically.

For instance, a small hydraulic (ram) cylinder may be mounted on the variable compression relief valve. A small hydraulic piston pump riding on a cam operates the hydraulic cylinder and subsequently the variable compression relief valve. The opening height and duration of opening of the variable compression relief valve is selected for the particular engine. The cam is located on the existing engine camshaft or any shaft that turns in synchronization with the engine. A cam lobe pushes the pump piston, forcing fluid through a hydraulic line to the hydraulic (ram) piston that controls the variable compression relief valve, thereby opening the variable compression relief valve.

To alter the variable compression relief valve timing in relation to the piston/crankshaft, the pump is moved to alter the relief valve timing relative to the piston and existing valve timing. For example, the pump is mounted on a plate that is concentric with the camshaft. As the plate is rotated clockwise (CW) or counter-clockwise (CCW), the timing of the variable compression relief valve can be advanced or retarded in relation to piston travel. Rotation of the pump plate may be achieved via any suitable means, such as, for exemplary purposes only, the use of a solenoid or mechanical actuator.

When raising or lowering the compression via solenoid actuation of the hydraulic pump plate, the solenoid receives input from the oxygen (O.sub.2) sensor, manifold absolute pressure (MAP) sensor, and/or anti-knock sensor. Additionally, other sensors utilize to optimize engine performance and efficiency, such as, for exemplary purposes only, sensors that send control signals to fuel injectors to increase fuel supplied to the engine, can also be utilized to control compression via the relief valve. In addition, a fuel sensor located in the fuel storage tank or the fuel delivery line senses the type of fuel and sends control signals to the timing mechanism controlling the relief valve.

In addition to moving the pump plate, a solenoid can be incorporated in the pressure line to dump the hydraulic pressure to the variable compression relief valve to retain maximum design compression if variable compression is not needed. Further, the timing plate can be rotated to a point where the variable compression relief valve closes before the intake valve closes for net effect thus maintaining maximum compression. Check valves are disposed in the gas/vent lines from the variable compression relief valves to prevent backflow of unfueled air from the intake manifold when the variable compression relief valve is open during a portion of the intake stroke.

In operation, as the piston reaches bottom dead center (BDC) the cam lobe will just be starting to apply pressure on the piston pump, which will, (via hydraulic line) open the variable compression relief valve. As the piston starts its compression stroke the variable compression relief valve will be held open for a given time to allow the escape of air/fuel mixture which if not vented, would result in a higher compression (pressure). The vented gas is subsequently routed back into the intake to be burned in later cycles. Once the relief valve is closed, compression will take place.

In another embodiment, electronic control is used to set the timing, lift, and dwell of the relief valve. This electronic control is preferably incorporated into or associated with the engine's electronic control unit, so that multiple input parameters can be used to dictate the appropriate operation of the compression relief valve.

Thus, the variable compression permits a wide variety of fuels to be utilized in a single design engine with the ability to switch between fuels merely by variation of timing of the opening of the variable compression relief valve. Such variation is readily accomplished from an external location on the engine without the need for engine modification.

### BRIEF DESCRIPTION OF THE SEVERAL VIEWS OF THE DRAWINGS

FIG. 1A is an elevation view, showing an internal combustion engine employing the present invention.

FIG. 1B is a detail view, showing one embodiment in which a cam is used to actuate the compression relief valve.

FIG. 2 is a sectioned elevation view, showing the compression relief valve and associated actuating mechanism.

FIG. 3 is a sectioned detail view, showing the compression relief valve.

FIG. 4 is a detail view, showing an embodiment in which mechanical means are used to vary the timing of the compression relief valve actuating mechanism.

FIG. 5 is polar plot showing the four cycles of a four-cycle engine relative to the rotation of a ½-speed timing shaft.

FIG. 6 is an elevation view of the timing mechanism, showing the use of a linear actuator.

FIG. 7 is a linear plot showing piston position and valve timing.

FIG. 8 is a linear plot showing the variables associated with the operation of the compression relief valve.

FIG. 9 is a linear plot of compression versus crank angle.

FIG. 10 is a linear plot of combustion chamber pressure versus crank angle.

FIG. 11 is a schematic view showing an alternate embodiment in which electronic control of the compression relief valve is employed.

FIG. 12 is a linear plot of combustion chamber pressure versus crank angle.

### REFERENCE NUMERALS IN THE DRAWINGS

10 engine
20 motor
30 relief valve system
40 hydraulic pump
50 hydraulic valve actuator
60 fluid line
70 timing adjustment and pump support plate
72 rotating plate
74 retarded extreme
76 advanced extreme
78 flexible coupling line
80 camshaft
82 linear actuator
84 anchor point
90 cam
100 cam lobe
110 crankshaft
114 peak lift
120 connecting rod
124 control solenoid
126 high pressure manifold
128 high pressure pump
130 piston
131 reservoir
132 pressure relief valve
134 compression relief controller
140 combustion chamber
150 intake valve
160 exhaust valve
170 intake
180 exhaust
190 compression relief valve
200 piston
210 spring
220 adjustment screw
230 locknut
240 pad
250 tensioning spring
260 cam follower plate
270 cam follower securing/locking mechanism
280 fine timing adjustment plate
290 fine adjustment slot
300 fine timing locking mechanism
310 first check valve
320 second check valve
330 first return line
340 second return line
350 valve cover
360 head
370 carburetor/intake manifold
380 timing adjustment slot
390 timing adjustment locking mechanism
410 hydraulic cylinder
420 hydraulic ram
430 relief valve spring
440 relief valve spring retainer
450 relief valve stem
460 relief valve guide
470 first venting port
480 second venting port
490 relief valve seat
500 valve height adjustment mechanism
510 housing
520 spring
530 rest
540 wheel
550 center

### DETAILED DESCRIPTION OF THE INVENTION

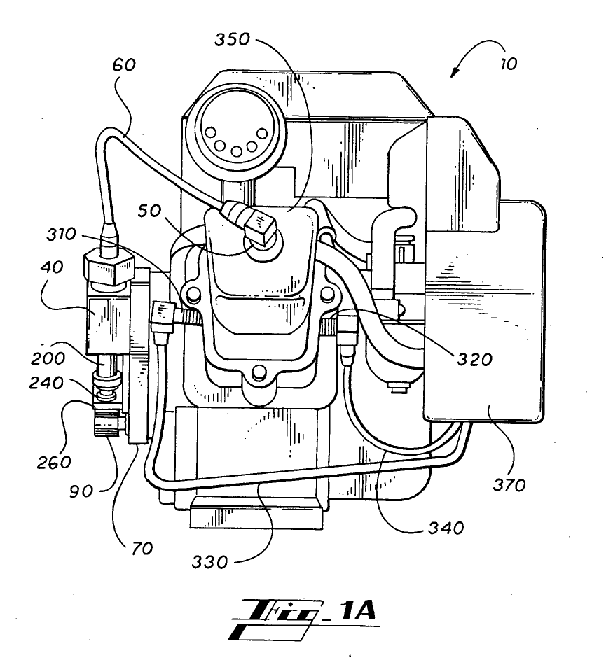

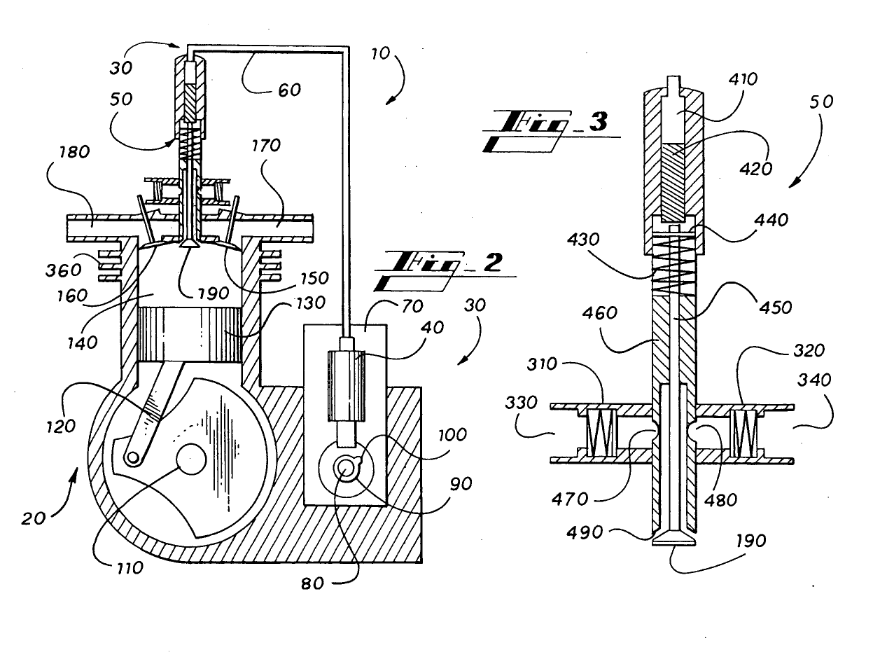

In describing the preferred and selected alternate embodiments of the present invention, as illustrated in FIGS. 1A-12, specific terminology is employed for the sake of clarity. The invention, however, is not intended to be limited to the specific terminology so selected, and it is to be understood that each specific element includes all technical equivalents that operate in a similar manner to accomplish similar functions.

Referring now to FIGS. 1A-3, a simple embodiment of the present invention will be described. Engine 10 preferably comprises motor 20 and compression relief valve system 30. Motor 20 preferably comprises crankshaft 110, connecting rod, 120, piston 130, combustion chamber 140, valve cover 350, head 360 and camshaft 80, wherein camshaft 80 preferably comprises cam 90 disposed thereon, and wherein cam 90 preferably comprises cam lobe 100. Head 360 preferably comprises compression relief valve 190, relief valve seat 490, intake 170 and exhaust 180, wherein intake 170 and exhaust 180 respectively preferably comprise intake valve 150 and exhaust valve 160.

Compression relief valve system 30 preferably comprises hydraulic pump 40, hydraulic valve actuator 50 hydraulic fluid line 60 and timing adjustment and pump support plate 70, wherein hydraulic valve actuator 50 and hydraulic pump 40 are preferably in fluid communication via hydraulic fluid line 60.

Hydraulic valve actuator 50 preferably comprises first check valve 310, second check valve 320, first return line 330, second return line 340, hydraulic cylinder 410, hydraulic ram 420, relief valve spring 430, relief valve spring retainer 440, relief valve stem 450, relief valve guide 460, first venting port 470 and second venting port 480.

Pump support plate 70 preferably comprises timing adjustment slot 380, wherein timing adjustment slot 380 preferably permits movement of pump support plate 70, and movement of pump support plate 70 concentrically around camshaft 80 selectively controls the opening point of valve 190. Timing adjustment locking mechanism 390 preferably secures pump support plate 70, while preferably permitting pump support plate 70 to be moved and subsequently locked into a selected timing position. It will be recognized by those skilled in the art that any means of providing rotation of pump might be utilized.

Hydraulic pump 40 preferably comprises piston 200, spring 210, adjusting screw 220, locknut 230 and pad 240, wherein adjusting screw 220 preferably permits extension or retraction of pad 240, and wherein adjusting screw 220 is preferably secured in position via locknut 230, and wherein spring 210 preferably biases piston 200 into extension.

Cam follower plate 260 is preferably disposed on cam follower securing/locking mechanism 270, wherein tensioning spring 250 is preferably connected between cam follower plate 260 and timing adjustment locking mechanism 390, wherein tensioning spring 250 preferably biases cam follower plate to contact pad 240 of hydraulic pump 40.

In an alternate embodiment of the present invention, pump support plate 70 preferably has disposed thereon fine timing adjustment plate 280, wherein fine timing adjustment plate 280 preferably comprises fine adjustment slot 290. Fine timing locking mechanism 300 preferably comprises fine adjustment slot 290, wherein height adjustment slot 290 preferably permits movement of fine timing adjustment plate 280. Fine timing locking mechanism 300 preferably secures fine timing adjustment plate 280, while preferably permitting fine timing adjustment plate 280 to be moved and subsequently locked into a selected position. In this fashion, the profile of the timing diagram and/or the lift of relief valve 190 can be altered, such that relief valve 190 can be controlled to snap shut, or to remain open through a selected angle of rotation of crankshaft 110.

In operation, camshaft 80 turns one rotation for every two rotations of crankshaft 110. Lobe 100 presses cam follower plate 260 against pad 240, thereby moving piston 210 into hydraulic pump 40. As piston 210 moves into hydraulic pump 40, it hydraulically forces hydraulic ram 420 to open compression relief valve 190, thereby hydraulically timing and controlling relief valve 190. It will be recognized by those skilled in the art that mechanisms other than hydraulic could be utilized to time the opening of relief valve 190, such as, for exemplary purposes only, pneumatic mechanism, or electric solenoid.

The duration of opening of compression relief valve 190 is selected by the size (in degrees) of cam lobe 100. By selecting the position of cam lobe 100 on camshaft 80, compression relief valve 190 is opened at any selected stage of the engine cycle. Once such initial opening point is selected, timing of opening of compression relief valve 190 is varied by movement of pump plate 70 by concentric rotation of pump plate 70 around camshaft 80.

Theoretically, intake valve 150 closes at BDC. However, most engines take advantage of the fact that the piston doesn't move substantially relative to crankshaft rotation near BDC and the column inertia of the moving stream of incoming fuel/air helps charge the cylinder for a brief period, even after the piston has changed direction. Thus, the intake valve will often remain open past BDC.

Setting intake valve 150 to close at 70 degrees ABDC will permit fuel/air to continue to move into combustion chamber 140. Setting camshaft 80 to open compression relief valve 190 at BDC and for a 70 degree duration ABDC, results in closure of compression relief valve 190 at 70 degrees ABDC, coincident with closure of intake valve 150 with no compression release.

Thus, during a portion of the compression stroke, compression relief valve will be open while all other valves are closed. This permits fuel/air mix to be removed via compression relief valve 190 through venting ports 470, 480, wherein the fuel/air mix passes through check valves 310, 320 and return lines 330, 340 to a fuel supply device, such as carburetor/intake manifold 370.

It will be further recognized by those skilled in the art that other methods of timing the opening of relief valve, such as, for exemplary purposes only, computer/electronic control of timing or a valve in hydraulic line 60, could be utilized without departing from the spirit and scope of the instant invention.

However, unless check valves 310, 320 are utilized, raw air could be pulled through the compression relief valve into combustion chamber 140, wherein check valves 310, 320 ensure no backwards flow of air into combustion chamber 140. It will be recognized by those skilled in the art that fewer, or additional, check valves could be utilized without departing from the spirit and scope of the present invention.

By selection of the maximum compression that an engine is capable of handling, timing of compression relief valve 190 can reduce the compression when it is desired to utilize other fuels. In a preferred example, for use with ethanol, an engine is designed to have a compression ratio of about 15 to 1. When it is desired to utilized gasoline in the same engine without modification thereof, the compression must be reduced since current gasoline would normally be limited to a compression ratio of approximately 8.5 to 1. By opening relief valve 190 in a combustion chamber 140/piston 130 combination that is designed for 15 to 1, the compression is reduced to provide an effective compression ratio of 8.5 to 1 for gasoline.

Cam 90/cam lobe 100 combination, or other means such as solenoid or mechanical means to operate pump 40, are selected for an open duration of compression via hydraulic pressure to keep relief valve 190 open for 70 degrees. Selective rotation of pump plate 70 is subsequently utilized to retard opening and, subsequently, closing of compression relief valve 190 by 10 degrees, and, thus, compression relief valve 190 opens 10 degrees ABDC and closes at 80 degrees ABDC, thus closing 10 degrees after, or later, than the closing of intake valve 150. Accordingly, compression is lost during the 10 degree duration after closure of intake valve 150 until the closure of compression relief valve 190. If timing adjustment/pump support plate 70 is moved to additionally retard closing of compression relief valve 190, more compression is lost. Thus, timing of opening and closing of compression relief valve 190 can be selectively utilized to accommodate the requirements of different fuels in the same engine without modification through the use of timable hydraulic control of relief valve 190.

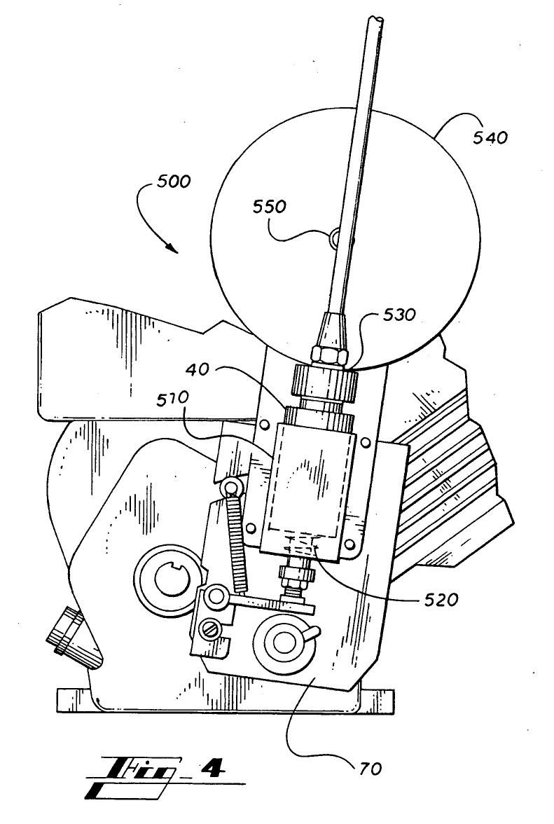

Referring now more specifically to FIG. 4, illustrated therein is an alternate embodiment of device 10, wherein the alternate embodiment of FIG. 4 is substantially equivalent in form and function to that of the preferred embodiment detailed and illustrated in FIGS. 1A-3 except as hereinafter specifically referenced. Specifically, the embodiment of FIG. 4 additionally comprises valve height adjustment mechanism 500, wherein valve height adjustment mechanism 500 permits the lift (height above valve seat 490) of compression relief valve 190 to be raised or lowered. Valve height adjustment mechanism 500 comprises pump 40, housing 510, spring 520, rest 530 and wheel 540. Pump 40 is disposed within housing 510, wherein pump 40 is mounted on spring 520. Wheel 540 is mounted off center 550, wherein rotation of wheel 540 eccentrically compresses and relieves against rest 530 to move pump 40 against or away from spring 520, thereby altering position of pad 240. By moving pad 240 away from cam follower 260, relief valve 190 will be opened to a lesser extent than if pad 240 is moved closer to cam follower 260. It will be recognized by those skilled in the art that levers or other suitable means could be utilized to selectively move pump 40 in lieu of wheel 540 and rest 530.

In control of opening of relief valve 190, it is of great importance that the appropriate opening point and height of relief valve 190 be selected and timed. Due to the increase in pressure in combustion chamber 140, late opening of relief valve 190 to too great a height could result in rapid pressure release. (The same height early in the compression stroke will have little effect since little pressure has built up.) By utilizing a low lift height for relief valve 190 when the pressure in combustion chamber 140 is high, controlled release of pressure can be accomplished.

A small amount of lift at 100 degrees (or any selected optimum point) will reduce compression slightly. If compression relief valve 190 is not opened, the maximum compression of the engine will be achieved. If compression relief valve 190 is opened, or opened higher, compression will be reduced, since more venting occurs, even though the opening point of compression relief valve remains the same. In this alternate embodiment, the timing of opening of compression relief valve 190 can also remain fixed, yet a small variation in compression can be obtained via valve height adjustment mechanism 500 via selection of the optimum point to open relief valve 190 and release pressure.

In another alternate embodiment of the present invention, the optimum, or ideal, point ABDC on the compression stroke is determined and timing adjustment/pump support plate 70 is set to close compression relief valve 190 at such optimum, such as, for exemplary purpose only, 100 degrees ABDC. From this point, compression can be varied by an additional amount via by increasing the height, or lift, of compression relief valve 190. While the preferred embodiment moves the opening and closing point of the compression relief valve, the alternate embodiment does not move the opening point once selected, but keeps the opening point and controls valve height to alter compression. So long as selection of the opening and closing points of relief valve 190 result in positive pressure within combustion chamber 140, check valves 310, 320 are not required.

It will be recognized by those skilled in the art that while the present invention discloses and discusses the compression relief valve with respect to only one cylinder, it is suited for internal combustion engines comprising a plurality of cylinders, without departing from the spirit and scope of the present invention. In such engines, fuel/air mix could be returned via return lines 330, 340 to an intake manifold. Accordingly, check valves 310, 320 serve to prevent fuel/air from entering combustion chamber 140 via return lines 330, 340 and ports 470, 480 during an intake stroke of a multi-cylinder engine.

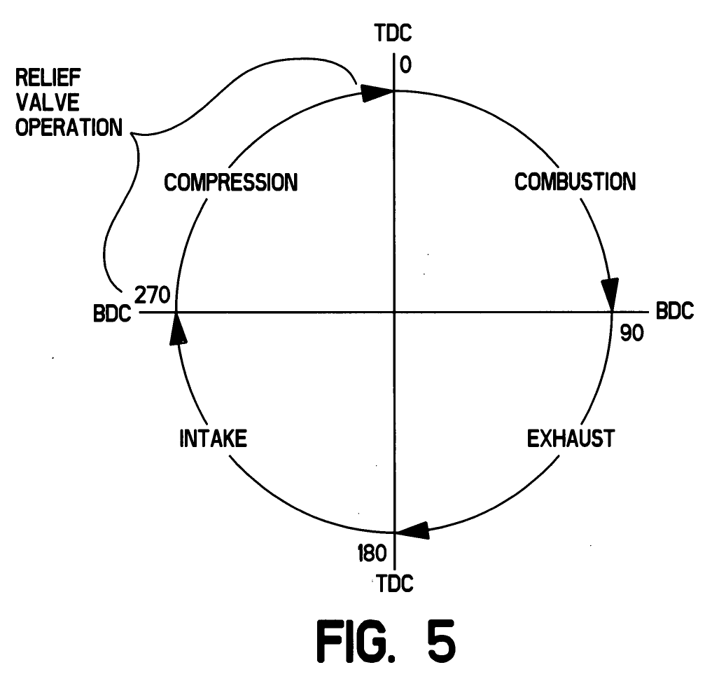

Those skilled in the art will also recognize that more complex controls than those illustrated and described previously are desirable for a modern multi-cylinder engine. Accordingly, examples of these more complex control systems will now be described with respect to FIGS. 5-12.

FIG. 5 shows a polar plot of an engine timing cycle for one cylinder only. The term “timing cycle” describes the rotation of an engine's timing components, which would typically include camshafts, a distributor in the case of a gasoline engine, and an injector pump in the case of a diesel engine. Timing components in a four-cycle engine run at ½ the rotational speed of the crankshaft. Thus, the 360 degree rotation of a timing component shown in FIG. 5 represents a 720 degree crankshaft rotation (meaning the completion of the four cycles).

The 0 degree position by convention denotes the piston being top dead center (“TDC”) at the conclusion of the compression cycle (and therefore at or around the time of ignition. The compressed charge is ignited and the combustion cycle continues through ninety degrees of timing component rotation, until the piston reaches bottom dead center (“BDC”) at the 90 degree position. The timing cycle then continues as the piston rises during the exhaust stroke. The exhaust stroke continues until TDC is again reached at the 180 degree position. The intake stroke follows as the piston again descends toward BDC at the 270 degree position.

The timing components can be used to (crudely) allow an engine to run on a variety of fuels. However, the timing components cannot alter an engine's compression ratio. Thus, the use of the timing components alone to accommodate different fuels is an inefficient solution.

The present invention takes a different approach by using a separate compression relief valve. The portion of the cycle between 270 degrees and 360 degrees is the compression stroke (with the piston rising again toward TDC). The compression relief valve is configured to operate in this portion of the cycle. The compression relief valve can be set to open one or more times between the 270 and 360 degree positions. Of course, it does take some time to open the compression relief valve and initiate decompressing flow through the valve. Thus, as those skilled in the art will know, there may be applications where it is advantageous to open the compression relief valve even before the 270 degree position. Thus, the range of operation for the compression relief valve may be thought of as lying between about 260 degrees and 360 degrees on the timing cycle.

Modern engines operate over a wide speed range. A typical idle speed is about 700 RPM. A gasoline engine is usually designed to “redline” at about 6,000 to 7,000 RPM with a diesel engine redlining at about 4,000 to 4,500 RPM. Ignition and fuel injection timing is varied over this speed range. Using ignition as an example, some automotive engines set the ignition at about 1 degree before TDC at idle but advance it by as much as 5 degrees near the RPM limit. In other words, the timing of the spark which ignites the combustion cycle in a gasoline engine is not fixed with respect to the angle of the crankshaft. It is altered depending on the engine speed. This alteration of the ignition timing is critical to engine performance.

The alteration of the timing of the compression relief valve is also desirable. As the engine speed increases, fluid inertia effects mean that the compression relief valve must be opened for a greater percentage of the compression stroke in order to produce the same proportional pressure reduction. Alternatively, the compression relief valve can be opened for the same amount of time, but later in the compression stroke when the pressure in the cylinder is higher and the exhaust flow will therefore be faster. Those skilled in the art will also know that as engine speed increases a valve's opening and closing time becomes more significant in comparison to the total open time. Thus, the total time of opening may need to be increased with increasing engine speed (increasing “dwell”).

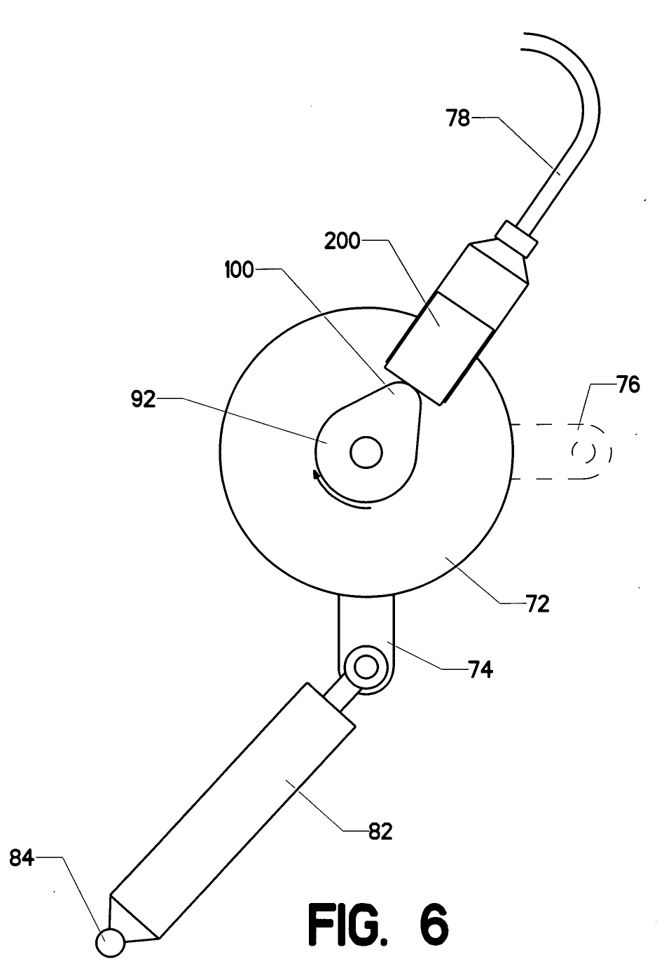

FIG. 6 shows one possible way of altering the timing of the compression relief valve. Any mechanism used for this purpose must be fairly fast-acting, since an engine can go from idle speed to redline in 1-2 seconds. Pressure relief cam 92 rotates with the other components of the timing cycle at ½ crankshaft speed. Cam lobe 100 acts upon piston 200 to actuate the pressure relief valve circuit once per revolution of pressure relief cam 92. Piston 200 is mounted on rotating plate 72. Linear actuator 82 is fixed to anchor point 84 on one end and to rotating plate 74 on its opposite end. The linear actuator can rapidly extend and retract, thereby moving rotating plate 72 from retarded extreme 74 to advanced extreme 76.

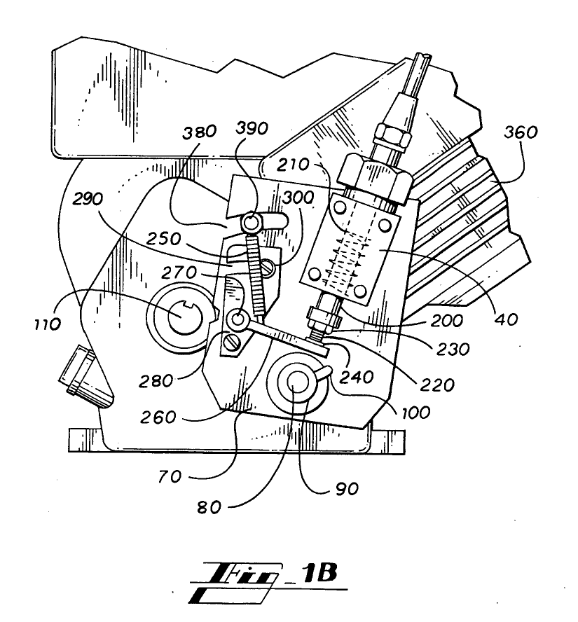

Flexible coupling line 78 connects the hydraulic pulse generated by the action of cam lobe 100 on piston 200 to fluid line 60 (shown in FIG. 2) and then onto the compression relief valve. The use of the linear actuator to rotate the rotating plate thereby permits the peak opening of the compression relief valve to be placed anywhere in the compression stroke. Further, the use of a hydraulic dump line allows the lift of the compression relief valve to be varied. The use of such a “dump valve” id described in detail elsewhere in this application and in U.S. Pat. No. 4,502,425, which is hereby incorporated by reference. Thus, the use of a timing device such as shown in FIG. 6 can shift the point of peak opening of the compression relief valve with respect to the crank angle. The use of a variable lift device can alter the amount of peak opening and the length of time the valve is open “dwell.” Thus, the reader will appreciate that it is possible to vary the timing, lift, and dwell of the compression relief valve.

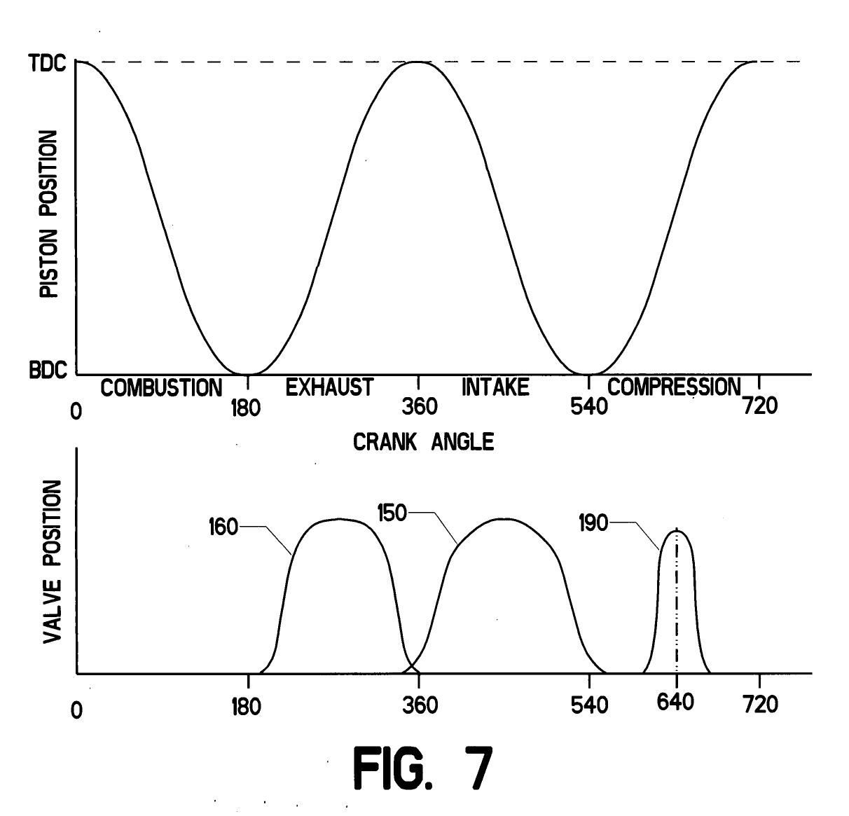

FIG. 7 shows a linear plot of valve position and piston position. The upper plot shows piston position versus crankshaft angle. This assumes a sinusoidal curve, with the piston cycling between TDC and BDC. The four cycles are also labeled in the view (combustion, exhaust, intake, and compression).

The lower plot shows valve position versus crankshaft angle. Exhaust valve 160 opens in the 180 to 360 degree crankshaft region. Intake valve 150 then follows between about 360 degrees and about 540 degrees. Finally compression relief valve is opened during the compression stroke (with the opening in this example being centered at 640 degrees). The reader will observe that the compression relief valve does not tend to over lap with the operation of the other valves (though the opening of the compression relief valve may overlap slightly with the closing of the intake valve).

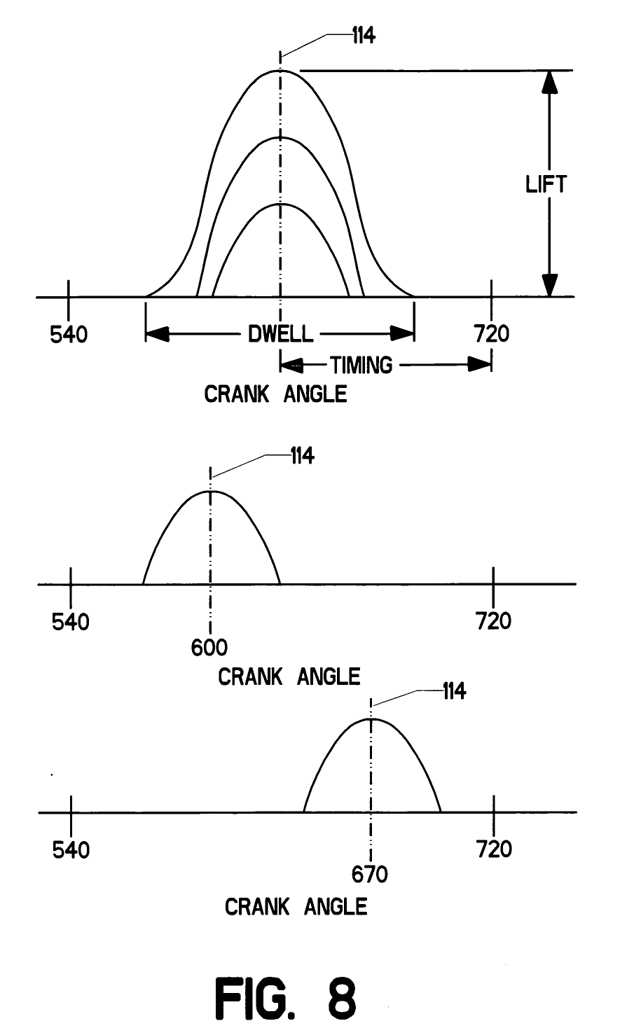

FIG. 8 shows three plots of compression relief valve lift versus crank angle. The upper view shows how lift can be varied (using a hydraulic dump line, a variable lift hydraulic valve lifter between pressure relief cam 92 and piston 200, etc.). Three separate lift heights are illustrated. This corresponds to three separate settings for the hydraulic dump line or hydraulic valve lifter. The reader will note that the point of peak lift 114 stays centered on a vertical line. However, as lift increases, so does dwell. This is a function of all cam operated valves. Dwell is often related to peak lift.

The middle and lower plots of FIG. 8 show how the timing of peak lift 114 can be shifted with respect to the crank angle. Two examples are shown. In the middle plot, peak lift 114 occurs at a crank angle of 600 degrees. In the bottom plot, peak lift 114 occurs at 670 degrees. These plots represent the shifts in timing that can be produce by a mechanism such as shown in FIG. 6.

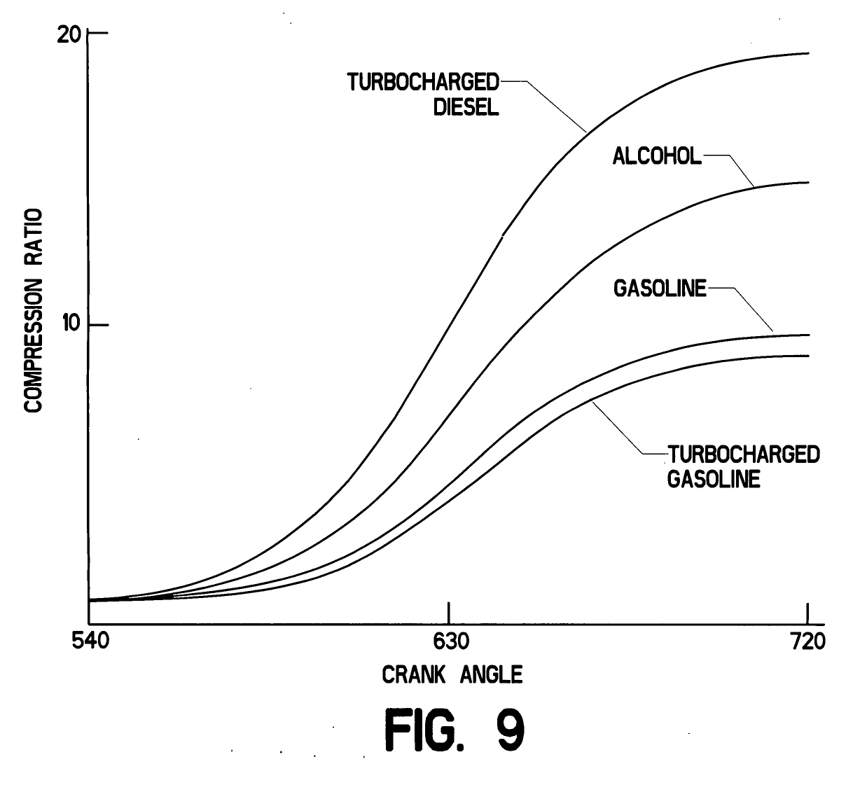

FIG. 9 shows a plot of compression ratio versus crank angle for a single cylinder in a four-cycle engine. The reader will appreciate that the compression ratio is the ratio of the pressure within the cylinder at any given point versus the pressure in the intake manifold. The crank position shown spans 540 degrees to 720 degrees, which represents the compression stroke of the piston from BDC to TDC. The maximum compression ratio occurs at TDC. This value is typically simply referred to as an engine's “compression ratio” rather than its “maximum compression ratio.”

The curves shown in FIG. 9 will be familiar to engine designers. A turbocharged diesel typically uses a compression ratio of around 19 to 1. An alcohol engine uses a compression ratio f about 15 to 1. A normally aspirated gasoline engine uses a compression ratio of about 9 to 1, whereas a turbocharged gasoline engine may use a compression ratio as low as 7 to 1.

The present invention allows a single geometry to mimic all the compression ratio curves shown in FIG. 9. In order to do this, the engine geometry is created to follow the maximum compression ratio curve desired. For the options shown in FIG. 9, this would mean building the engine geometry suitable for a turbocharged diesel cycle. The compression relief valve can then be used to reduce the pressure if the user desires to run the engine on one of the other fuels.

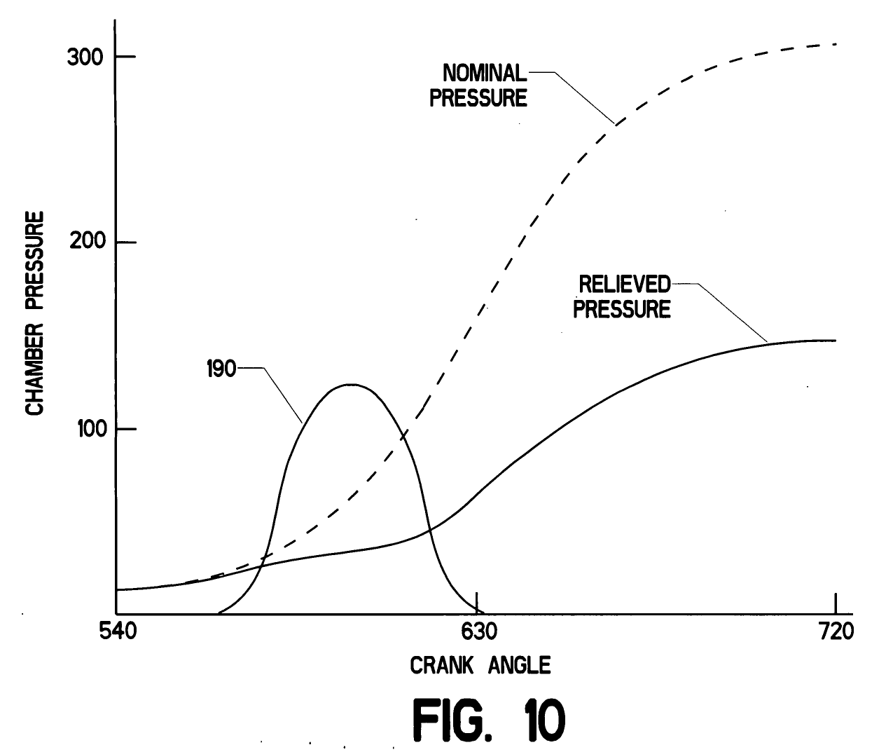

FIG. 10 shows a plot for a case where the engine is to be run on gasoline. FIG. 10 actually is a plot of chamber pressure (in psi) against crank angle (rather than compression ratio against crank angle). The reader will observe that as the crankshaft passes through the 540 degree position and the piston rises, the chamber pressure rises. At about the 560 degree position, however, compression relief valve 190 begins to open. The relief valve can be sized and/or controlled to either reduce the chamber pressure, hold the chamber pressure steady, or reduce the rate of increase of the chamber pressure. As one example, varying the peak lift—such as by using a variable hydraulic lifter between relief cam 92 and piston 200—can select among these effects.

In the example shown in FIG. 10, compression relief valve 190 is actually opened to an extent sufficient to reduce the chamber pressure. The nominal chamber pressure that would exist without the use of the relief valve is shown as a dashed line in the view. The reader will observe how the chamber pressure drops during the dwell of the compression relief valve. Once the compression relief valve closes—at approximately the 620 degree position, the chamber pressure again rises through the remainder of the compression stroke. However, the maximum pressure reached corresponds to the desired amount for a normally aspirated gasoline engine. Whereas the diesel cycle would produce a peak chamber pressure of about 300 psi, the gasoline cycle is only about 140 psi—owing to the operation of the compression relief valve.

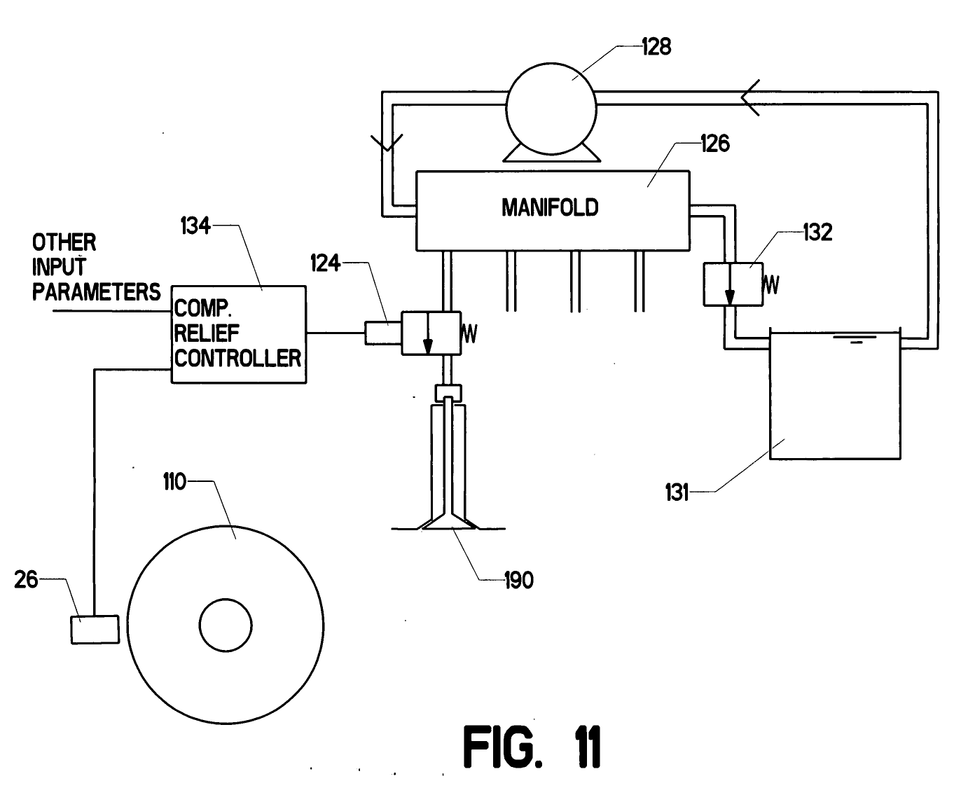

Different lift, timing, and dwell for the compression relief valve can be employed to mimic virtually any compression curve. However, those skilled in the art will realize that the use of mechanisms to accomplish this goal will be very complex. It therefore makes sense to employ modern microprocessor-based control techniques. FIG. 11 is a schematic representation of one potential embodiment of such a system. Hydraulic pressure is supplied to compression relief valve 190 by high pressure pump 128. It feeds pressurized hydraulic fluid to high pressure manifold 126. Pressure relief valve 132 maintains the appropriate pressure within high pressure manifold 126. it returns excess hydraulic fluid back to reservoir 131, which feeds the pump.

Control solenoid 124 selectively supplies hydraulic pressure from high pressure manifold 126 to compression relief valve 190. Compression relief controller 134 selectively energizes control solenoid 124 to open compression relief valve 190. Crank angle sensor 26 senses the rotational position of crankshaft 110 and sends a timing signal to compression relief controller 134. Compression relief controller preferably receives other input parameters (such as engine speed, exhaust oxygen content, manifold vacuum, etc.) from the engine control unit (“ECU”). In fact, it is possible to use a suitably modified ECU to control the control solenoid directly (though obviously a power amplifying device is necessary).

The use of a control solenoid allows the compression relief valve to be opened for short pulses, extended periods, or anything in between. The use of rapid pulse cycles can be advantageous, since it can provide pressure relief which is similar to the operation of pulse-width-modulated electrical drive units.

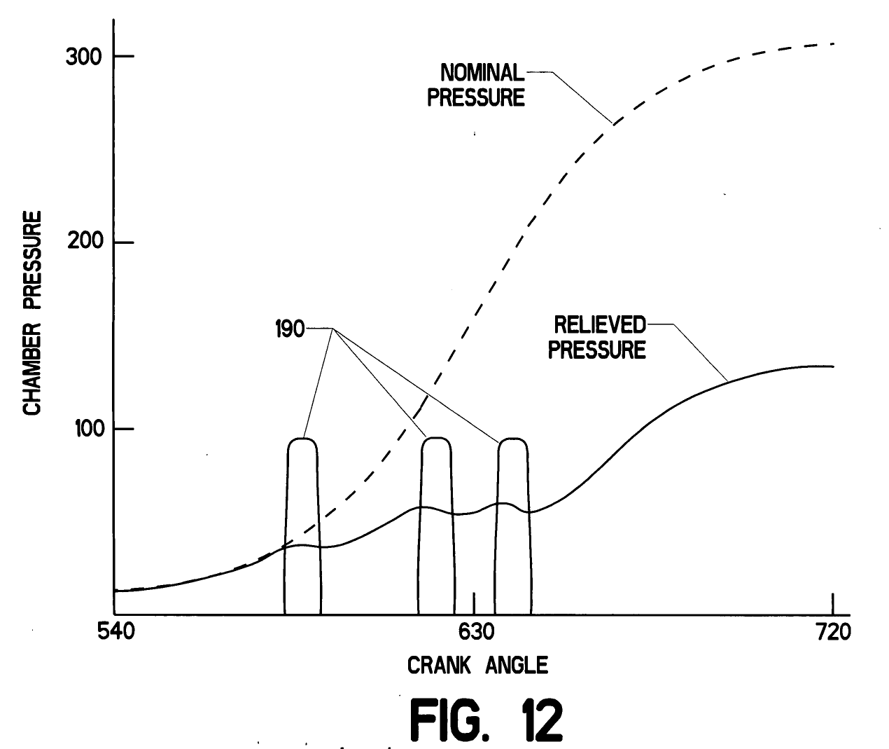

FIG. 12 shows a plot of chamber pressure versus crank angle where pulsed operation of compression relief valve 190 is employed. The dashed line again represents the pressure curve which would exist without the operation of the pressure relief valve. Three pulses of the relief valve are employed to modify the pressure curve as shown. The result is that the maximum pressure reached is suitable for an alcohol-fueled engine. By using a different number of pulses or pulses of different duration, the pressure curve can be modified in other ways. The timing of the pulses with respect to the crank angle is preferably also variable.

The use of electronic control is therefore preferable for the application of the compression relief valve to a modern automotive engine. It is even possible to use electrical power to directly open and close the valve, though this would consume a considerable amount of power and generate substantial heat.

The reader will thereby appreciate that the present invention uses timing and lifting mechanisms that are separate from the timing and lifting mechanisms used for the prior art intake and exhaust valves. The compression relief valve can be operated completely independently of the intake and exhaust valves, and is in no way dependent upon their operation. Further, the point of opening, dwell, point of closing, and peak lift of the compression relief valve can preferably all be controlled (through there may be some relationships linking these parameters).

The foregoing description and drawings comprise illustrative embodiments of the present invention. Having thus described exemplary embodiments of the present invention, it should be noted by those skilled in the art that the within disclosures are exemplary only, and that various other alternatives, adaptations, and modifications may be made within the scope of the present invention. Many modifications and other embodiments of the invention will come to mind to one skilled in the art to which this invention pertains having the benefit of the teachings presented in the foregoing descriptions and the associated drawings. Although specific terms may be employed herein, they are used in a generic and descriptive sense only and not for purposes of limitation. Accordingly, the present invention is not limited to the specific embodiments illustrated herein, but is limited only by the following claims.

Having described my invention, I claim:

1. A variable compression engine having a rotating crankshaft and a reciprocating piston attached thereto, wherein once per revolution said crankshaft reaches an angular position corresponding to a bottom dead center position of said piston, said engine also having a compression stroke and an intake valve, wherein said variable compression engine comprises:
a. a compression relief valve disposed within a combustion chamber of said engine;
b. a compression relief valve actuator configured to open said relief valve and hold said compression relief valve open during a portion of said compression stroke after said intake valve has closed;
c. wherein for each time said compression relief valve is opened said compression relief valve reaches a point of peak opening; and
d. wherein said point of peak opening is variable with respect to said angular position of said crankshaft corresponding to a bottom dead center position of said piston.

2. A variable compression engine as recited in claim 1, wherein said compression relief valve actuator is capable of varying the lift of said compression relief valve.

3. A variable compression engine as recited in claim 1, wherein said compression relief valve actuator is capable of varying the dwell of said compression relief valve.

4. A variable compression engine as recited in claim 2, wherein said compression relief valve actuator is capable of varying the dwell of said compression relief valve.

5. The variable compression engine of claim 1, further comprising a cam-operated mechanism.

6. The variable compression engine of claim 5, wherein said cam-operated mechanism is in hydraulic communication with said compression relief valve.

7. The variable compression engine of claim 6, wherein said cam-operated mechanism is operated by a camshaft rotating once for every two revolutions of said crankshaft.

8. The variable compression engine of claim 1 further comprising at least one check valve in fluid communication with said compression relief valve.

9. The variable compression engine of claim 8, wherein said at least one check valve prevents flow into said combustion chamber via said compression relief valve.

10. A variable compression engine having a rotating crankshaft and a reciprocating piston attached thereto, wherein once per revolution said crankshaft reaches an angular position corresponding to a bottom dead center position of said piston, said engine also having a compression stroke and an intake valve, wherein said variable compression engine comprises:
a. a compression relief valve disposed within a combustion chamber of said engine; and
b. a compression relief valve actuator configured to open said relief valve and hold said compression relief valve open for a plurality of pulse cycles during a portion of said compression stroke after said intake valve has closed.

11. The variable compression engine of claim 10, wherein:
a. for each time said compression relief valve is opened in said plurality of pulse cycles said compression relief valve reaches a point of peak opening; and
b. wherein said points of peak opening are variable with respect to said angular position of said crankshaft corresponding to a bottom dead center position of said piston.

12. A variable compression engine as recited in claim 10, wherein said compression relief valve actuator is capable of varying the lift of said compression relief valve.

13. A variable compression engine as recited in claim 10, wherein said compression relief valve actuator is capable of varying the dwell of said compression relief valve.

14. A variable compression engine as recited in claim 12, wherein said compression relief valve actuator is capable of varying the dwell of said compression relief valve.

15. The variable compression engine of claim 10 further comprising at least one check valve in fluid communication with said compression relief valve.

16. The variable compression engine of claim 15, wherein said at least one check valve prevents flow into said combustion chamber via said compression relief valve.

17. The variable compression engine of claim 10, further comprising:
a. a hydraulic pump; and
b. a control solenoid connecting said hydraulic pump to said compression relief valve.

18. The variable compression engine of claim 17, further comprising a compression relief controller for actuating said control solenoid and thereby connecting said high pressure pump to said compression relief valve.

19. The variable compression engine of claim 18, wherein said compression relief controller comprises an engine control unit.

20. The variable compression engine of claim 18, wherein said compression relief controller is synchronized to the rotation of said crankshaft by a crank angle sensor.
